(19) United States
(12) Patent Application Publication
(10) Pub. No.: US 2025/0250820 A1
(43) Pub. Date: Aug. 7, 2025

(54) LOCKING MECHANISM FOR A FASTENER RECEPTACLE ASSEMBLY

(71) Applicant: Toyota Motor Engineering & Manufacturing North America, Inc., Plano, TX (US)

(72) Inventor: Christopher Charles Daigle, London (CA)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/434,969

(22) Filed: Feb. 7, 2024

(51) Int. Cl. E05B 13/00; B65D 55/14; E05B 65/52; E05C 1/12

(52) U.S. Cl. CPC E05B 13/002; B65D 55/14; E05B 65/523; E05C 1/12

(57) ABSTRACT

A locking mechanism is provided for releasably maintaining a lid of a fastener receptacle assembly in a closed and locked condition. The locking mechanism may include a rotatable actuator. A lid lock may be operably connected to the actuator so that the lid lock moves to a locking position responsive to rotation of the actuator to a first angular orientation, and so that the lid lock moves to an unlocking position responsive to rotation of the actuator to a second angular orientation. A lid latch may be structured to be engageable with the lid lock when the lid lock is in the locking position, and structured to be disengaged from the lid lock when the lid lock is in the unlocking position.

### TECHNICAL FIELD

The present invention relates to locking mechanisms and, more particularly, to a locking mechanism structured to maintain a lid of a fastener receptacle assembly in a closed and locked condition, and structured to be releasable only by a movement of a fastener having predetermined characteristics through the locking mechanism.

### BACKGROUND

Receptacles such as storage bins and hoppers may be used for storing and/or dispensing quantities of small, uniform fastener components such as screws, nuts, and bolts. Slight differences in the sizes or geometries of such components may not be easily determinable by a user, and this may lead to confusion as to whether a component should be placed in a receptacle containing components which may be similar, yet dimensionally different. If different components are stored in the same receptacle, this condition may not be discovered until someone attempts to use an incorrect component in an assembly, which may lead to down time and possible scrapping or time-consuming sorting of the components in the receptacle.

### SUMMARY

In one aspect of the embodiments described herein, a locking mechanism is provided for releasably maintaining a lid of a fastener receptacle assembly in a closed and locked condition. The locking mechanism may include a rotatable actuator. A lid lock may be operably connected to the actuator so that the lid lock moves to a locking position responsive to rotation of the actuator to a first angular orientation, and so that the lid lock moves to an unlocking position responsive to rotation of the actuator to a second angular orientation. A lid latch may be structured to be engageable with the lid lock when the lid lock is in the locking position, and structured to be disengaged from the lid lock when the lid lock is in the unlocking position.

### BRIEF DESCRIPTION OF THE DRAWINGS

The accompanying drawings, which are incorporated in and constitute a part of the specification, illustrate various systems, methods, and other embodiments of the disclosure. In some embodiments, one element may be designed as multiple elements or multiple elements may be designed as one element. In some embodiments, an element shown as an internal component of another element may be implemented as an external component and vice versa. Furthermore, elements may not be drawn to scale. Also, unless otherwise stated or shown, the same or similar elements shown in different views may be given the same or similar reference numerals or designations.

FIG. 1 is a schematic perspective front view of a fastener receptacle assembly incorporating a locking mechanism in accordance with an embodiment described herein.

FIG. 2 is a schematic front perspective view of a locking mechanism in accordance with an embodiment described herein, showing part of the mechanism cut away to show interior details of a fastener-receiving cavity of the locking mechanism.

FIG. 2A is a magnified view of a portion of the locking mechanism shown in FIG. 2.

FIG. 3 is a schematic partial cross-sectional perspective view of a portion of the locking mechanism shown in FIG. 2, shown without a fastener positioned in the fastener-receiving cavity, and showing a first rotor rotation prevention portion of a key rotated into a key-receiving slot of the mechanism.

FIG. 4A is the view of FIG. 3, showing a fastener positioned in the fastener-receiving cavity, and showing the first rotor rotation prevention portion of the key rotated out of the key-receiving slot.

FIG. 4B is a magnified schematic view of a portion of a rear of the mechanism shown in FIG. 4A, showing the first rotor rotation prevention portion of the key rotated out of the key-receiving slot.

FIG. 5 is a view similar to the view of FIG. 4A, showing a fastener positioned in the fastener-receiving cavity, and showing an over-length fastener received in the fastener-receiving cavity.

FIG. 6A is a schematic view of a rear of the locking mechanism, with a fastener positioned in the fastener-receiving cavity in a start orientation and prior to rotation of a rotor of the mechanism to release a lid latch to enable opening of a receptacle for the fastener.

FIG. 6B is the view of FIG. 6A after rotation of the rotor assembly 90° from the start orientation to enable movement of a locking shaft out of engagement with a lid latch, to enable opening of the receptacle lid.

FIG. 6C is the view of FIG. 6B after opening of the receptacle lid and rotation of the rotor assembly a further 90° from the start orientation to enable the fastener positioned in the fastener-receiving cavity to drop into the receptacle, and to reset a locking shaft of the lid lock to a locking position.

FIG. 7 is the view of FIG. 6C, showing re-engagement of the lid latch with a locking shaft of the lid lock as the receptacle lid is closed, to lock the lid.

### DETAILED DESCRIPTION

A locking mechanism is provided for releasably maintaining a lid of a fastener receptacle assembly in a closed and locked condition. The locking mechanism may include a rotatable actuator. A lid lock may be operably connected to the actuator so that the lid lock moves to a locking position responsive to rotation of the actuator to a first angular orientation, and so that the lid locking shaft moves to an unlocking position responsive to rotation of the actuator to a second angular orientation. A lid latch may be structured to be engageable with the lid lock when the lid lock is in the locking position, and structured to be disengaged from the lid lock when the lid lock is in the unlocking position. The locking mechanism is releasable by inserting a fastener having predetermined specifications into the locking mechanism when the actuator is the first angular orientation, then rotating actuator to the second angular orientation so that the lid locking shaft moves to its unlocking position. The locking mechanism may prevent access to an interior of the receptacle except for loading of a quantity of fasteners of the predetermined specifications into the receptacle.

The various elements set forth in the following description may be fabricated from any material or materials (e.g., metals, polymers, etc.) suitable for the purposes described herein.

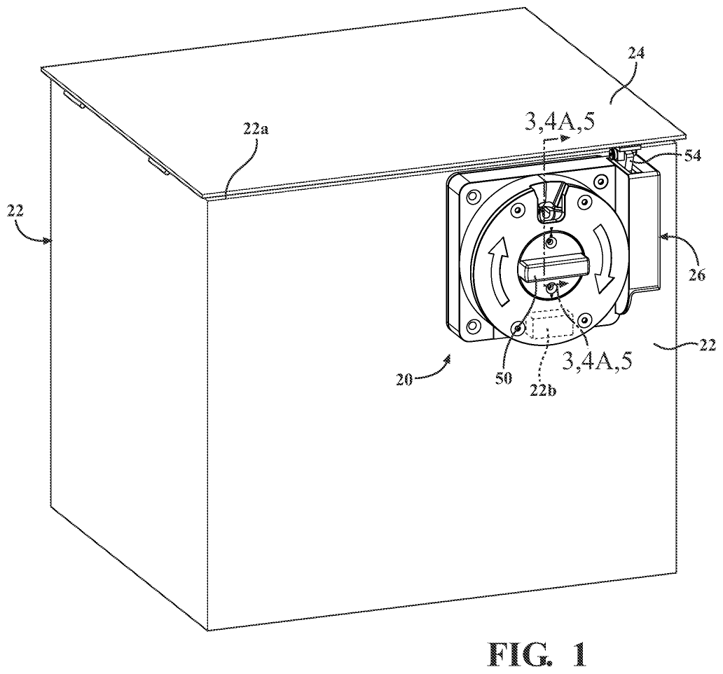

FIG. 1 is a schematic perspective front view of a fastener receptacle assembly 20 incorporating a locking mechanism 26 in accordance with an embodiment described herein. The fastener receptacle assembly 20 may be used for securely storing a quantity of identical fasteners (such as bolts for example) having predetermined specifications, such as thread specifications, length, head thickness, etc. As described herein, the locking mechanism 26 may be structured to maintain a lid 24 of the receptacle in a closed and locked condition, and to prevent the lid 24 from being opened by a user unless the user is able to (a) position a fastener having predetermined specifications in a fastener-receiving cavity of the locking mechanism, and (b) rotate the fastener-receiving cavity at least a predetermined amount (e.g., 90°) to unlock the lid.

The receptacle assembly 20 may include a receptacle 22 having a top opening 22a structured to allow a batch or quantity of the identical fasteners to be poured into the receptacle 22 simultaneously. The receptacle 22 may also include a side opening 22b positioned so as to reside opposite a funneling structure 56 (described in greater detail below) of the locking mechanism 26 when the locking mechanism is mounted on the receptacle 22, to enable a fastener rotated through the locking mechanism 26 to exit the mechanism into receptacle 22 as described herein. Lid 24 may be operably connected to the receptacle 22 by a hinge or other mechanism so as to be rotatable with respect to the receptacle 22. The lid 24 may be structured to cover the top opening 22a of the receptacle 22 to prevent access to the receptacle interior when the lid is closed. The term “operably connected,” as used throughout this description, can include direct or indirect connections, including connections without direct physical contact.

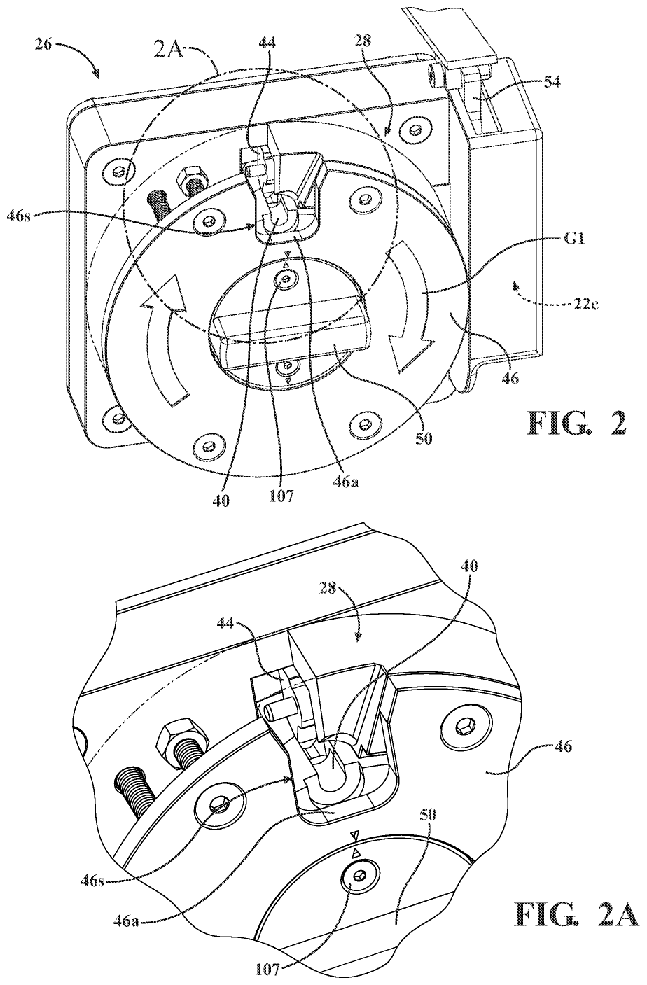

Referring to the drawings, locking mechanism 26 may be mounted along a side of the receptacle 22 and may be operably connected to lid 24 to maintain the lid in a closed and locked condition until a fastener having the desired characteristics has been rotated through the locking mechanism, as described herein. Referring to FIGS. 2A-7, the locking mechanism 26 may include a base portion 28 structured to be attachable to the receptacle 22 using fasteners, adhesive, or some other suitable means. The base portion 28 may be structured to receive therein a portion of a rotor assembly mounting shaft 98 (not shown). The rotor assembly mounting shaft 98 may enable a rotor assembly 30 of the locking mechanism 26 to be rotatably connected to the base portion 28 (i.e., the rotor assembly 30 is connected to the base portion 28 so as to be rotatable with respect to the base portion). The base portion 28 may also include a latch chamber 22c structured to contain and guide the motion of a lid latch 54 as described herein, during opening and closing of the lid 24.

Rotor assembly 30 may be rotatably connected to the base portion 28 via rotor assembly mounting shaft 98, to enable a suitably-sized fastener positioned in a fastener-receiving cavity of the rotor assembly to be rotated through the locking mechanism 26 to the locking mechanism funneling structure 56. The rotor assembly 30 may include a hub portion 32 rotatably connected to the base portion via shaft 98. The hub portion 32 may include a shaft-receiving cavity 32a extending therethrough. The base portion 28 may include a bearing cavity 26a housing a roller bearing 34 structured to engage shaft 98 to enable rotation of the hub portion 32, an actuator 36, and a fastener-receiving portion 38 with respect to the base portion 28.

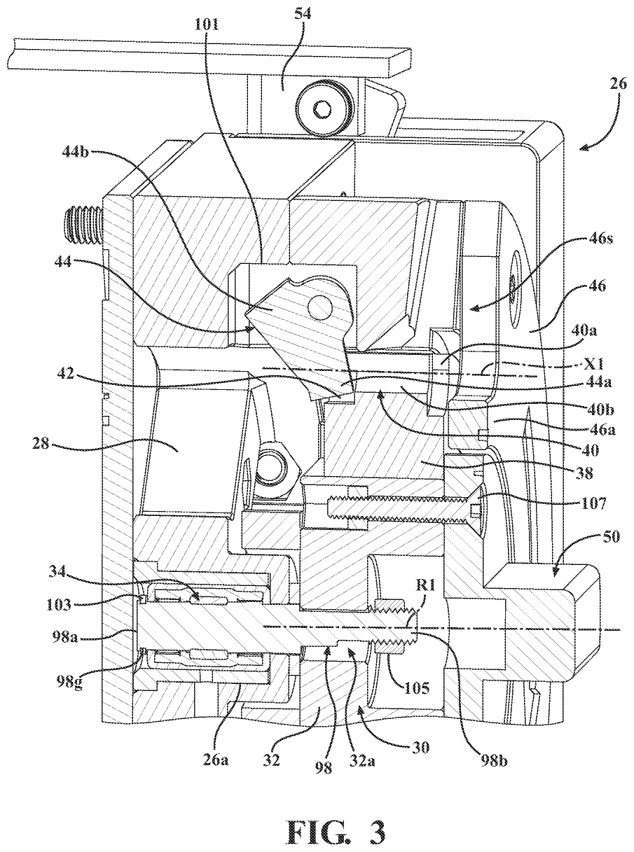

Referring to FIG. 3, in one or more arrangements, mounting shaft 98 may include a first end 98a, a second end 98b opposite the first end 98a, and a body 98c extending between and connecting the first and second ends 98a, 98b. Shaft first end 98a may have a groove 98g formed therein and structured for receiving therein a retaining ring 103. Shaft second end 98b may be threaded to enable application of a nut 105 thereto.

To secure the hub portion 32 to the base portion 28, the hub portion 32 may be brought into physical contact with the base portion 28 so that shaft-receiving openings of the hub portion 32 and base portion 28 are aligned along rotational axis R1 as shown in FIG. 3. The shaft 98 may then be inserted into hub portion shaft-receiving cavity 32a and through the base portion 28 until the shaft first end 98a extends from a rear of the bearing cavity 26a. Retaining ring 103 may then be applied to the groove 98g to retain the shaft first end 98a in the base portion 28. Then, nut 105 may be applied to shaft second end 98b to secure hub portion 32 to base portion 28, so that the hub portion 32 may be rotated with respect to the base portion 28.

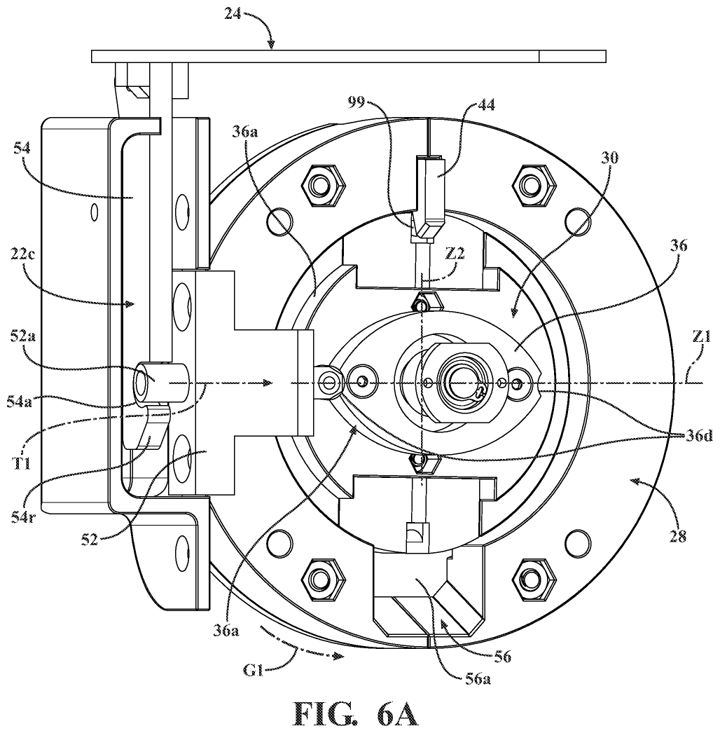

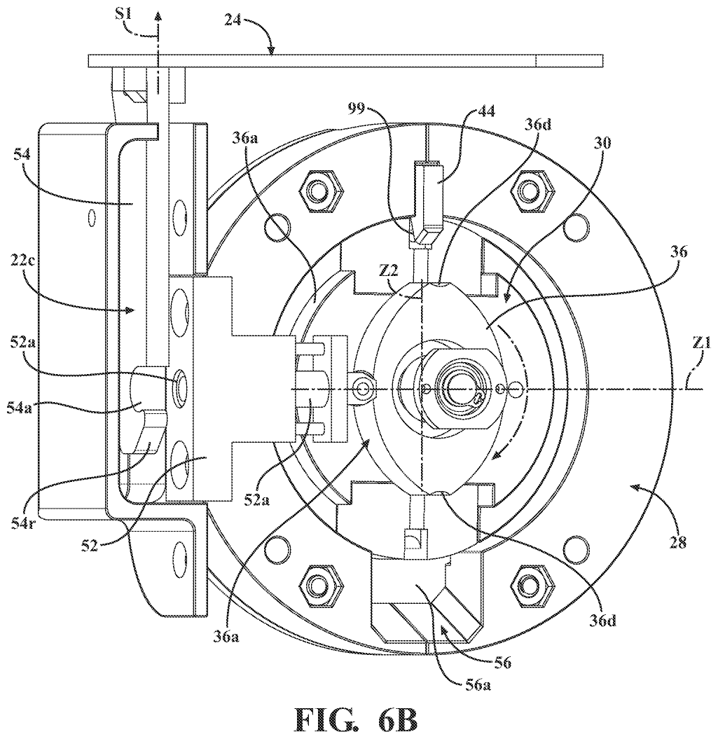

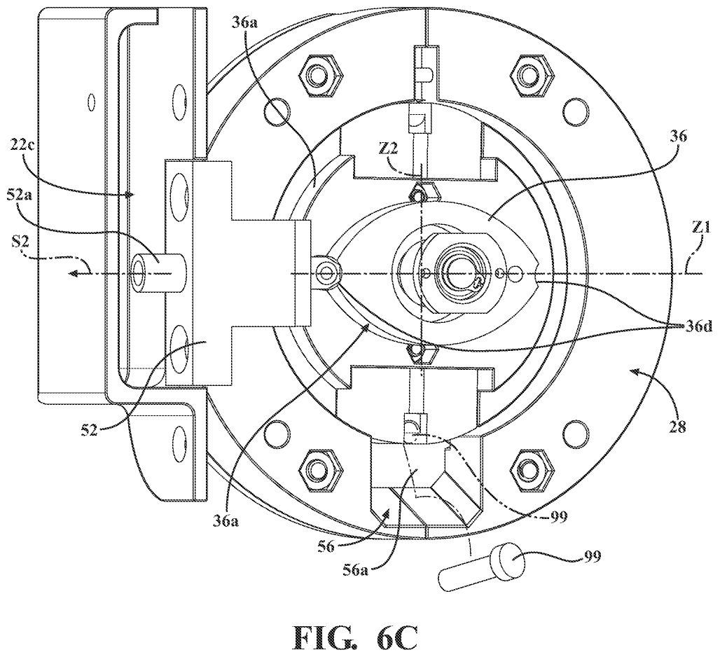

Referring to FIGS. 6A-6C, lid locking shaft actuator 36 may be rotatably connected to the base portion 28 and may be rotationally coupled to the hub portion 32 (i.e., the actuator 36 may be coupled to the hub portion 32 so that it turns simultaneously with the hub portion and at the same angular rate as the hub portion). The actuator 36 may include an actuation surface 36a structured to contact a locking shaft 52a of a lid lock 52 during rotation of the actuator, to control movement of the lid locking shaft 52a as described herein during operation of the locking mechanism. In one or more arrangements, the actuation surface 36a has an oval or elliptical shape defined by an outermost edge of the actuator and structured to engage the lid locking shaft 52a in a camming action. Opposed ends of the actuator 36 located along the actuation surface 36a may include detents 36d as shown in FIG. 6A. Detents 36d may be structured to hold the actuator 36 in an orientation in which the actuator urges the locking shaft 52a away from the rotational axis R1 of the rotor assembly 30 and into its locking position, until at least a minimum predetermined rotation force is applied to the knob 50 by a user. In the elliptical actuator shown in FIGS. 6A-6C, the detents 36d are formed in locations along a major axis Z1 of the elliptical shape.

The rotor assembly 30 may also include a fastener-receiving portion 38 rotationally coupled to the hub portion 32. In some arrangements, the fastener-receiving portion 38 may be structured to extend along an outer periphery of hub portion 32. In one or more arrangements, fastener-receiving portion 38 may be in the form of an insert structured to be detachably mounted on the hub portion 32 so as to be removable from the hub portion 32. This may enable the fastener-receiving portion 38 to be swapped out from the locking mechanism 26 to accommodate fasteners having various head thicknesses and shank lengths.

The fastener-receiving portion 38 may include a fastener-receiving cavity 40 structured for rotation with the fastener-receiving portion 38. The fastener-receiving cavity 40 may be structured to receive therein a fastener having an overall length L1 within a predetermined range, including a head having a predetermined maximum thickness T1. The predetermined range may be determined by applicable overall length tolerances for any specific configuration of fastener.

The fastener-receiving cavity 40 may have longitudinal axis X1 extending parallel to a rotational axis R1 of the fastener-receiving portion/rotor assembly. In one or more arrangements, the axis X1 may be coaxial with a longitudinal axis of a suitable fastener to be positioned in the fastener-receiving cavity 40. The fastener-receiving cavity 40 may include a head-receiving portion 40a structured to receive a head 99a of a bolt 99 or similar fastener, when the head has a specific shape (e.g., hexagonal, round, etc.) and the head has up to a specific predetermined thickness T1. The fastener-receiving cavity 40 may also include a shank-receiving portion 40b structured to receive a shank 99b of the bolt/fastener, when the shank and the head combine to have an overall length L1 within a predetermined range.

The fastener-receiving cavity 40 may also include key-receiving slot 42 extending contiguously with the shank-receiving portion 40b. Key-receiving slot 42 may be structured to receive therein a first rotor rotation prevention portion 44a of a key 44 (described in greater detail below) when a fastener is not positioned in the fastener-receiving cavity 40 (or when an under-length fastener is positioned in the fastener-receiving cavity). An “under-length fastener” may be a fastener having an overall length L1 that is insufficient to move the first rotor rotation prevention portion 44a out of the key-receiving slot 42 when a fastener is positioned in the fastener-receiving cavity 40.

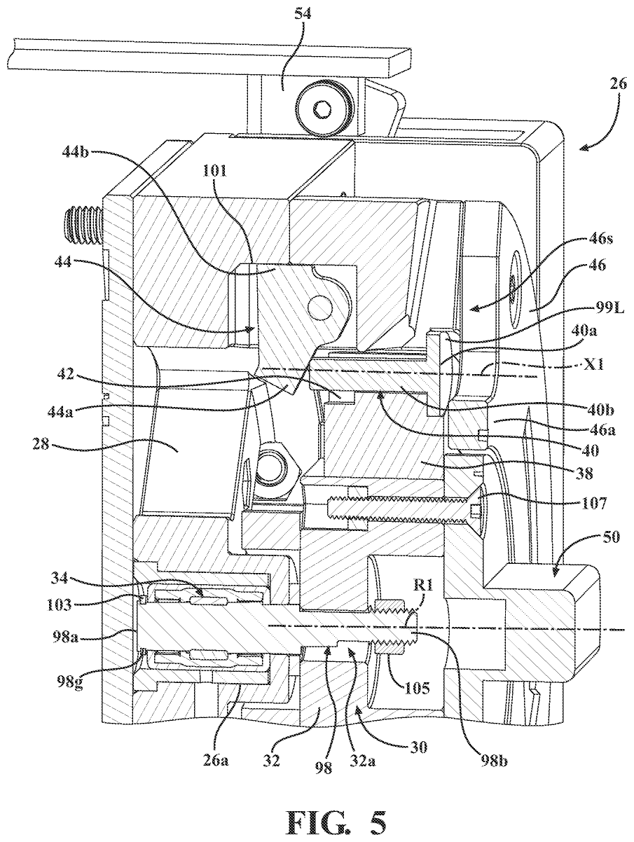

Key 44 may be rotatably connected to base portion 28. The key may include first rotor rotation prevention portion 44a structured to rotate into the key-receiving slot 42 when no fastener is positioned in the fastener-receiving cavity 40. In one or more arrangements, the key 44 may be spring-loaded or otherwise biased so that the first rotor rotation prevention portion 44a automatically rotates into the key-receiving slot 42 when no fastener is positioned in the fastener-receiving cavity 40. Referring to FIG. 5, the key 44 may further include a second rotor rotation prevention portion 44b structured to bear against a surface 101 of the base portion 28 when the key rotates out of key-receiving slot 42 responsive to insertion of an over-length fastener 99L into the fastener-receiving cavity 40. An “over-length” fastener may be a fastener having an overall length L1 that exceeds the predetermined range. The key 44 and base portion 28 may be structured so that friction between the second rotor rotation prevention portion 44b and the surface 101 of base portion 28 impedes or prevents rotation of the rotor assembly when an over-length fastener (such as fastener 99L) is positioned in the fastener-receiving cavity 40. This helps prevent the receptacle 22 from being opened if the fastener positioned in the fastener-receiving cavity 40 is the wrong size.

The fastener-receiving portion 38 may also include another fastener-receiving cavity and key (not shown) structured as just described and positioned angularly spaced-apart 180° from the fastener-receiving cavity 40 so as to reside opposite the fastener-receiving cavity 40.

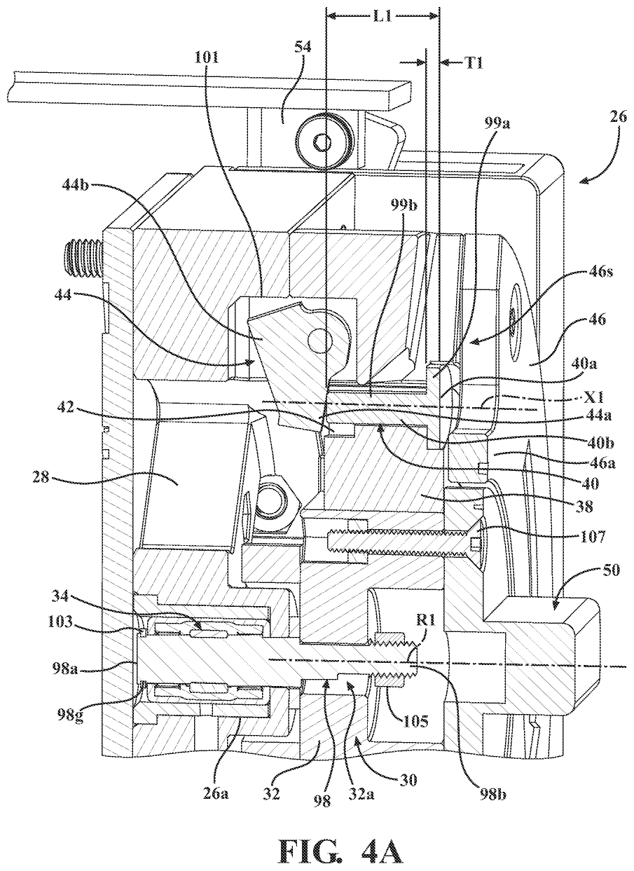

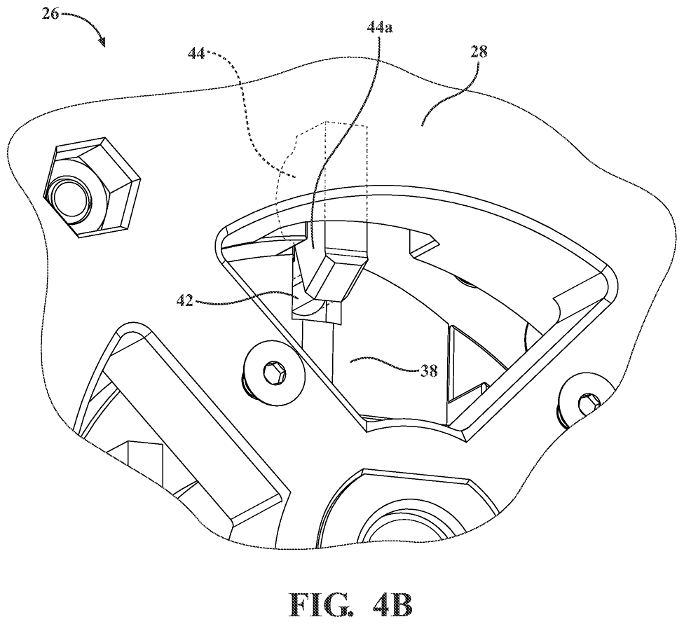

Referring to FIGS. 2 and 4A, a cover portion 46 may be attached to the hub portion 32 using any suitable method, such as screws or other mechanical fasteners. In one or more arrangements, the cover portion 46 may include an open-ended slot 46s including a fastener-retention edge 46a structured to define a side or boundary of the fastener-receiving cavity 40. The edge 46a may help retain an appropriately-sized fastener in the fastener-receiving cavity 40 after insertion and prior to rotation of the rotor assembly 30 to unlock the receptacle lid 24.

Referring to the drawings, a knob 50 may be rotationally coupled to the hub portion 32 using fasteners or any other suitable means. The knob may include a projection 50b structured for grasping by a user to rotate the rotor assembly 30. Knob 50 may be attached to hub portion 32 (e.g., using screws 107 or any other suitable attachment method) after the hub portion 32 has been secured to the base portion 28 as previously described, thereby rotationally coupling the hub portion 32 to the knob so that rotation of the knob 50 will also rotate the hub portion 32.

A lid lock 52 may include a shaft 52a that is spring-loaded so as to bias the shaft toward a rotational axis R1 of rotor assembly 30. locking shaft 52a may extend from the lid lock 52 extending to engage a lid latch 54 of the locking mechanism to maintain the receptacle lid in a closed and locked condition (i.e., a condition where the lid blocks access to the receptacle interior through the top opening 22a and engagement between the locking shaft 52a and the lid latch 54 prevents the lid 24 from being opened).

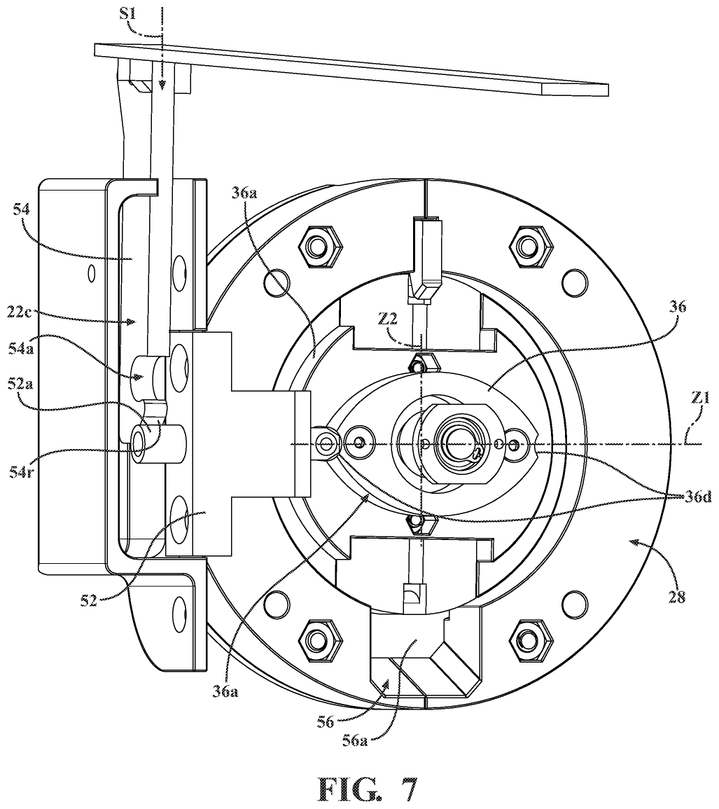

Lid latch 54 may be operably connected to receptacle lid 24. The lid latch may include a notch or groove 54a structured to receive therein locking shaft 52a of the lid lock 52 when the lid 24 is in a closed condition, to latch the lid and maintain the lid in the closed/locked condition. Lid latch 54 may include a ramp surface 54r structured to slide along the locking shaft 52a when the lid latch is moved in a closing direction S2 (FIG. 7) of the lid 24. The lid latch 54 may be structured to deflect as the ramp surface slides along the locking shaft 52a, and to snap back when the notch 54a reaches the locking shaft and receives the locking shaft therein, thereby locking the lid 24.

Referring to FIGS. 6A-6C, a funneling structure 56 may be secured to base portion 28 below rotor assembly 30. The funneling structure 56 may define a fastener discharge port 56a structured to receive a fastener 99 from the fastener-receiving cavity 40, to channel or direct the fastener 99 into the receptacle 22 as it drops out of the fastener-receiving cavity 40 after the rotor assembly 30 has been rotated 180° from the start orientation shown in FIG. 4A.

Operation of the locking mechanism 26 will now be described with reference to the drawings.

Referring to FIG. 4A, with the cover portion slot 46s oriented so as to open in a vertically upward direction and the fastener-receiving cavity 40 visible through the cover portion slot 46s, a user may attempt to insert a fastener 99 into the fastener-receiving cavity 40. As previously described, the fastener-receiving cavity 40 may be structured to receive therein a fastener having an overall length L1 within a predetermined range, including a head having a predetermined maximum thickness T1. Referring to FIGS. 4A and 4B, if a head 99a of the inserted fastener is too thick, the head will not fit in the cavity head-receiving portion 40a (e.g., the head will project out of the cavity 40 over the fastener-retention edge 46a of the cover portion 46). If a user then attempts to rotate the rotor assembly 30, the head will abut the fastener-retention edge 46a, preventing rotation of the rotor assembly. Also, referring to FIG. 5, if the overall length L1 of the fastener is excessive, the end of the fastener opposite the head end will over-rotate the key 44 to where the second rotor rotation prevention portion 44b contacts and bears against the base portion surface 101. The resulting engagement between rotation prevention portion 44b and the base portion surface 101 will resist or prevent rotation of the rotor assembly 30. Similarly, the fastener-receiving cavity 40 may also be structured to receive therein a fastener having a head 99a with a predetermined maximum outer diameter. If the outer diameter of the fastener head 99a is too large, the head will not fit in the cavity head-receiving portion 40a (e.g., the head will project out of the cavity 40), and rotation of the rotor assembly 30 will be prevented. Also, the fastener-receiving cavity 40 may also be structured to receive therein a fastener having a shank with a predetermined maximum outer diameter. If the outer diameter of the fastener shank 99b is too large, the shank will not fit in the cavity shank-receiving portion 40b (e.g., the shank will project out of the cavity 40), and rotation of the rotor assembly 30 will be prevented. However, if the fastener is the correct size, the fastener head 99a will fit inside the fastener-receiving cavity head-receiving portion 40a, the fastener shank 99b will fit inside the fastener-receiving cavity shank-receiving portion 40b, and an end of the fastener opposite the head end will move the first rotor rotation prevention portion 44a of the key 44 out of the key-receiving slot 42, thereby allowing the fastener-receiving portion 38 and the attached rotor assembly 30 to be rotated by the user. The user may rotate the rotor assembly 30 in direction G1 using knob 50. In the start orientation (FIG. 6A), it may be seen that a major axis Z1 of the elliptical actuation surface 36a extends essentially horizontally, thereby maintaining the locking shaft 52a engaged with the lid latch 54.

In an embodiment where the actuation surface 36a is elliptical and the rotor assembly 30 (and the included actuator 36) has been rotated 90° from the start orientation to the orientation shown in FIG. 6B, the major axis Z1 extends essentially vertically, while the minor axis Z2 of the surface extends essentially horizontally. It may also be seen from FIGS. 6A-6B that, as the actuator 36 rotates 90° from the start orientation, the spring-loaded lid locking shaft 52a moves in direction W1, toward the axis of rotation R1 of the rotor assembly 30, disengaging from the lid latch 54. This enables the lid latch 54 and the attached receptacle lid 24 to be moved upwardly in direction S1 toward an open orientation of the lid.

Referring to FIG. 6C, as the user continues to rotate the knob and actuator in direction G1 to 180° from the start orientation to the orientation shown in FIG. 6C, the actuator 36 reorients so as to urge the locking shaft 52a in direction W2 back to its locking position shown in FIG. 6A. When the actuator 36 has reached an orientation 180° from the start position, the fastener-receiving cavity 40 is aligned with the funneling structure 56, enabling the fastener 99 to fall out of the fastener-receiving cavity 40 and slide along the funneling structure 56 into the receptacle interior.

Referring to FIG. 7, after a quantity of fasteners 99 have been deposited into the opened receptacle 22, the lid 24 may be closed to move the lid latch 54 along the latch chamber 22c in direction S2. Lid latch ramp surface 54r slides along locking shaft 52a until notch 54a reaches the shaft 52a, whereupon the shaft snaps into the notch, locking the lid latch 54 and the lid 24.

In the above detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope of the invention.

What is claimed is:

1. A locking mechanism comprising:
a rotatable actuator;
a lid lock operably connected to the actuator so that the lid lock moves to a locking position responsive to rotation of the actuator to a first angular orientation, and so that the lid lock moves to an unlocking position responsive to rotation of the actuator to a second angular orientation; and
a lid latch structured to be engageable with the lid lock when the lid lock is in the locking position, and structured to be disengaged from the lid lock when the lid lock is in the unlocking position.

2. The locking mechanism of claim 1, wherein the actuator has an elliptical actuation surface.

3. The locking mechanism of claim 1, further comprising:
a hub portion; and
a fastener-receiving portion rotationally coupled to the hub portion, the fastener-receiving portion including a fastener-receiving cavity structured to receive therein a fastener having an overall length within a predetermined range, including a head having a predetermined maximum thickness.

4. The locking mechanism of claim 3, wherein the fastener-receiving portion comprises an insert detachably mounted on the hub portion so as to be removable from the hub portion.

5. The locking mechanism of claim 3, wherein the fastener-receiving cavity has a longitudinal axis extending parallel to a rotational axis of the fastener-receiving portion.

6. The locking mechanism of claim 3, wherein the fastener-receiving cavity includes a shank-receiving portion and a head-receiving portion.

7. The locking mechanism of claim 3, further comprising:
a base portion in contact with the hub portion;
a key-receiving slot formed in the hub portion and extending contiguously with a portion of the fastener-receiving cavity; and
a key rotatably secured to the base portion, the key including a first rotor rotation prevention portion structured to rotate into the key-receiving slot when no fastener is positioned in the fastener-receiving cavity or when an under-length fastener is positioned in the fastener-receiving cavity.

8. The locking mechanism of claim 7, further comprising a second rotor rotation prevention portion structured to contact a surface of the base portion when the key rotates responsive to insertion of an over-length fastener into the fastener-receiving cavity.

9. A receptacle assembly including a locking mechanism in accordance with claim 1.

10. The receptacle assembly of claim 9, further comprising a receptacle and a lid operably connected to the receptacle and to the lid latch, the lid being structured to cover an opening of the receptacle.
